(19) United States
(12) Patent Application Publication
(10) Pub. No.: US 2013/0133063 A1
(43) Pub. Date: May 23, 2013

(54) TUNNELING-BASED METHOD OF BYPASSING INTERNET ACCESS DENIAL

(71) Applicants: MARWAN H. ABU-AMARA, DHAHRAN (SA); MOHAMMED A. KHADIR KHAN ASIF, DHAHRAN (SA); MOHAMMED SQALLI, DHAHRAN (SA); ASHRAF MAHMOUD, DHAHRAN (SA); FARAG AZZEDIN, DHAHRAN (SA)

(72) Inventors: MARWAN H. ABU-AMARA, DHAHRAN (SA); MOHAMMED A. KHADIR KHAN ASIF, DHAHRAN (SA); MOHAMMED SQALLI, DHAHRAN (SA); ASHRAF MAHMOUD, DHAHRAN (SA); FARAG AZZEDIN, DHAHRAN (SA)

(73) Assignees: KING ABDULAZIZ CITY FOR SCIENCE AND TECHNOLOGY, RIYADH (SA); KING FAHD UNIVERSITY OF PETROLEUM AND MINERALS, DHAHRAN (SA)

(21) Appl. No.: 13/302,963

(22) Filed: Nov. 22, 2011

(51) Int. Cl. G06F 21/20

(52) U.S. Cl. 726/22

(57) ABSTRACT

The tunneling-based method of bypassing Internet access denial allows for the re-routing of communication between a local system and a destination system when the local system's Internet Protocol (IP) address has been blocked by a malicious higher-tier Internet service provider (ISP). If it is determined that the local system is blocked from communicating with the destination system, then it is determined if a malicious higher-tier ISP is responsible for the blockage of service. If the local system is blocked by the ISP, then the ISP is identified and communication is established between the local system and a neighboring system that is not blocked by the ISP. Finally, communications are then transmitted from the local system to the destination system, through the established tunnel, by first transmitting from the local system to the neighboring system, and then transmitting from the neighboring system through the ISP to the destination system.

### BACKGROUND OF THE INVENTION

1. Field of the Invention

The present invention relates to computer network protocols, and particularly to a tunneling-based method of bypassing Internet access denial by creating a bypass tunnel between a local system and a destination system.

2. Description of the Related Art

An IP tunnel is an Internet Protocol (IP) network communications channel between two networks. It is used to transport another network protocol by encapsulation of its packets. IP tunnels are often used for connecting two disjointed IP networks that do not have a native routing path to each other via an underlying routable protocol across an intermediate transport network. In conjunction with the Internet Protocol Security (IPsec) protocol, as will be described below, IP tunnels may be used to create a virtual private network between two or more private networks across a public network, such as the Internet.

In IP tunneling, every IP packet, including addressing information of its source and destination IP networks, is encapsulated within another packet format native to the transit network. At the borders between the source network and the transit network, as well as the transit network and the destination network, gateways are used that establish the end-points of the IP tunnel across the transit network. Thus, the IP tunnel endpoints become native IP routers that establish a standard IP route between the source and destination networks. Packets traversing these end-points from the transit network are stripped from their transit frame format headers and trailers used in the tunneling protocol, and thus converted into native IP format and injected into the IP stack of the tunnel endpoints. In addition, any other protocol encapsulations used during transit, such as IPsec or Transport Layer Security, are removed.

IP-in-IP, which is sometimes referred to as “ipencap”, is an example of IP encapsulation within IP. IP tunneling often bypasses simple firewall rules transparently since the specific nature and addressing of the original datagrams are hidden. Content-control software is usually required to block IP tunnels. IP-in-IP is an IP tunneling protocol that encapsulates one IP packet in another IP packet. To encapsulate an IP packet in another IP packet, an outer header is added with SourceIP, being the entry point of the tunnel, and DestinationIP being the exit point of the tunnel.

Computer networks use a tunneling protocol when one network protocol (the delivery protocol) encapsulates a different payload protocol. By using tunneling, one can, for example, carry a payload over an incompatible delivery-network, or provide a secure path through an untrusted network. Tunneling typically contrasts with a layered protocol model, such as those of OSI or TCP/IP. The delivery protocol usually operates at a higher level in the model than does the payload protocol, or at the same level.

As an example of network layer over network layer, Generic Routing Encapsulation (GRE), a protocol running over IP, often serves to carry IP packets with RFC 1918 private addresses over the Internet using delivery packets with public IP addresses. In this case, the delivery and payload protocols are compatible, but the payload addresses are incompatible with those of the delivery network. Tunneling protocols may use data encryption to transport insecure payload protocols over a public network (such as the Internet), thereby providing VPN functionality. Internet Protocol Security (IPsec) has an end-to-end Transport Mode, but can also operate in a tunneling mode through a trusted security gateway.

IPsec is a protocol suite for securing IP communications by authenticating and encrypting each IP packet of a communication session. IPsec also includes protocols for establishing mutual authentication between agents at the beginning of the session and negotiation of cryptographic keys to be used during the session.

IPsec is an end-to-end security scheme operating in the Internet Layer of the Internet Protocol Suite. It can be used in protecting data flow between a pair of hosts (host-to-host), between a pair of security gateways (network-to-network), or between a security gateway and a host (network-to-host). Some other Internet security systems in widespread use, such as Secure Sockets Layer (SSL), Transport Layer Security (TLS) and Secure Shell (SSH), operate in the upper layers of the TCP/IP model. Thus, IPsec protects any application traffic across an IP network.

Although tunneling protocols may be used for creating secure private networks within a public network, such as the Internet, they are not tools that typically may be used to bypass an Internet Service Provider (ISP) or other system that is maliciously blocking network access. Thus, a tunneling-based method of bypassing Internet access denial solving the aforementioned problems is desired.

### SUMMARY OF THE INVENTION

The tunneling-based method of bypassing Internet access denial allows for the re-routing of communication between a local system and a destination system when the local system's Internet protocol (IP) address has been blocked by a malicious higher-tier Internet service provider. First, it is determined if the local system is blocked from communicating with the destination system. If the local system is blocked from communicating with the destination system, then it is determined if a malicious higher-tier Internet service provider is responsible for the blockage of service.

If the local system is blocked by the malicious higher-tier Internet service provider, then the malicious higher-tier Internet service provider is identified and communication is established between the local system and a neighboring system that is not blocked by the malicious higher-tier Internet service provider. The neighboring system will then help in establishing either a secure or a non-secure tunnel between the local system and the destination system. Finally, communications are then transmitted from the local system to the destination system, through the established tunnel, by first transmitting from the local system to the neighboring system, and then transmitting from the neighboring system through the malicious higher-tier Internet service provider to the destination system.

These and other features of the present invention will become readily apparent upon further review of the following specification and drawings.

### BRIEF DESCRIPTION OF THE DRAWINGS

FIG. 1 is a block diagram of an exemplary network for use with a tunneling-based method of bypassing Internet access denial according to the present invention, showing alternate paths through the network between a client and a server using IP addressing.

FIG. 2A is a graph showing the baseline configuration for throughput between a router of a local system and a router of a malicious higher-tier Internet service provider.

FIG. 2B is a graph showing the baseline configuration for throughput between a router of a malicious higher-tier Internet service provider and a router of a local system.

FIG. 2C is a graph showing the baseline configuration for throughput between a router of a neighboring system and the router of the local system.

FIG. 2D is a graph showing the baseline configuration for throughput between the router of the local system and the router of the neighboring system.

FIG. 3 is a table showing the baseline configuration for Internet Protocol (IP) forwarding at the router of the local system.

FIG. 4 is a table showing the baseline configuration for Internet Protocol (IP) forwarding at the router of the malicious higher-tier Internet service provider.

FIG. 5 is a table showing the baseline configuration for Internet Protocol (IP) forwarding at the router of a destination system.

FIG. 6 is a table showing the tunnel configuration for Internet Protocol (IP) forwarding at the router of the local system.

FIG. 7 is a table showing the tunnel configuration for Internet Protocol (IP) forwarding at the router of the destination system.

FIG. 8A is a graph showing the tunnel traffic received by the router of the local system.

FIG. 8B is a graph showing the tunnel traffic sent by the router of the local system.

FIG. 8C is a graph showing the tunnel traffic received by the router of the destination system.

FIG. 8D is a graph showing the tunnel traffic sent by the router of the destination system.

FIG. 9 is a table showing a multiple-system tunnel configuration for Internet Protocol (IP) forwarding at the router of the local system.

FIG. 10 is a table showing the tunnel configuration for Internet Protocol (IP) forwarding in the multiple-system tunneling scheme of FIG. 9 at the router of a destination system.

FIG. 11 is a block diagram showing an exemplary alternative network for use with the tunneling-based method of bypassing Internet access denial according to the present invention, showing tunnels between network routers.

FIG. 12 is a table showing the configuration for border gateway protocol (BGP) forwarding at the router of a destination system.

FIG. 13 is a table showing the multiple-system tunnel configuration for Internet Protocol (IP) forwarding at the router of a destination system.

FIG. 14 is a block diagram showing an exemplary alternative network configuration for use with the tunneling-based method of bypassing Internet access denial according to the present invention, specifically for load balancing.

Similar reference characters denote corresponding features consistently throughout the attached drawings.

### DETAILED DESCRIPTION OF THE PREFERRED EMBODIMENTS

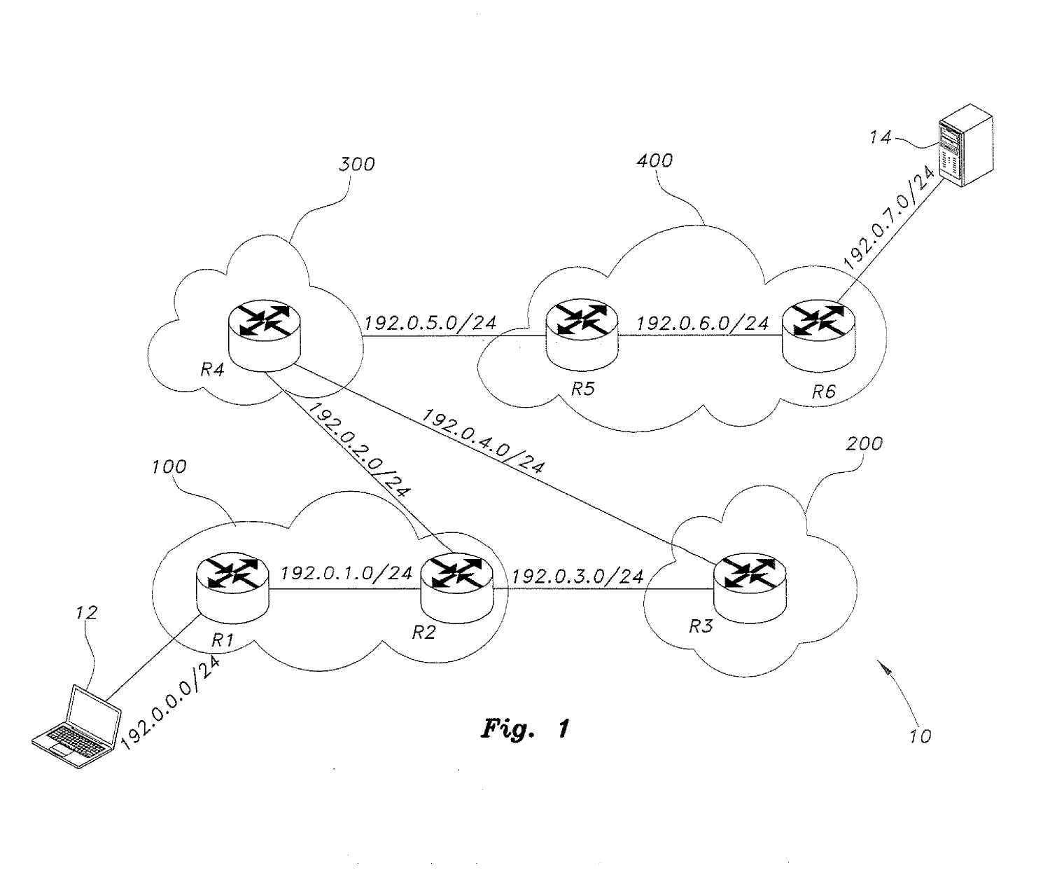

The tunneling-based method of bypassing Internet access denial allows for the re-routing of communication between a local system and a destination system when the local system's internet protocol (IP) address has been blocked by a malicious higher-tier Internet service provider. FIG. 1 illustrates a simplified exemplary network 10, in which a client 12 in a local system 100 attempts to communicate with a server 14 in a destination system 400 through an Internet service provider (ISP) 300.

As shown in FIG. 1, the client 12 is connected to both a local area network (LAN) through a first router R1 and also to a wide area network (WAN), which is the Internet in this example, through a second router R2. The local network system is generally designated as 100 in FIG. 1. Similarly, the server 14 is connected to its own LAN by a local router R6 and to the WAN through a router R5. The destination network system is generally designated as 400 in FIG. 1. ISP 300 similarly has its own router R4.

It should be understood that any suitable type of LAN, WAN, network access and router may be utilized. In the example of FIG. 1, an IP-based gateway is provided, which supports four Ethernet hub interfaces and eight serial line interfaces at selectable data rates. The gateway preferably also supports IP, UDP, RIP, Ethernet (IEEE 802.3), OSPF, and SLIP protocols. Each router preferably also supports the tunnel interfaces (to be described in detail below), and there is no restriction on the number of tunnels that can be established. IP packets arriving on any interface are routed to the appropriate output interface based on their destination IP address. The exemplary network 10 includes six such routers R1-R6, which are configured to support BOP protocol, and a tunnel is created from the gateway router R2 of the local system 100 to the gateway router R5 of the destination system 400. Neighboring or intermediate network 200, having its respective gateway router R3, is also shown in FIG. 1.

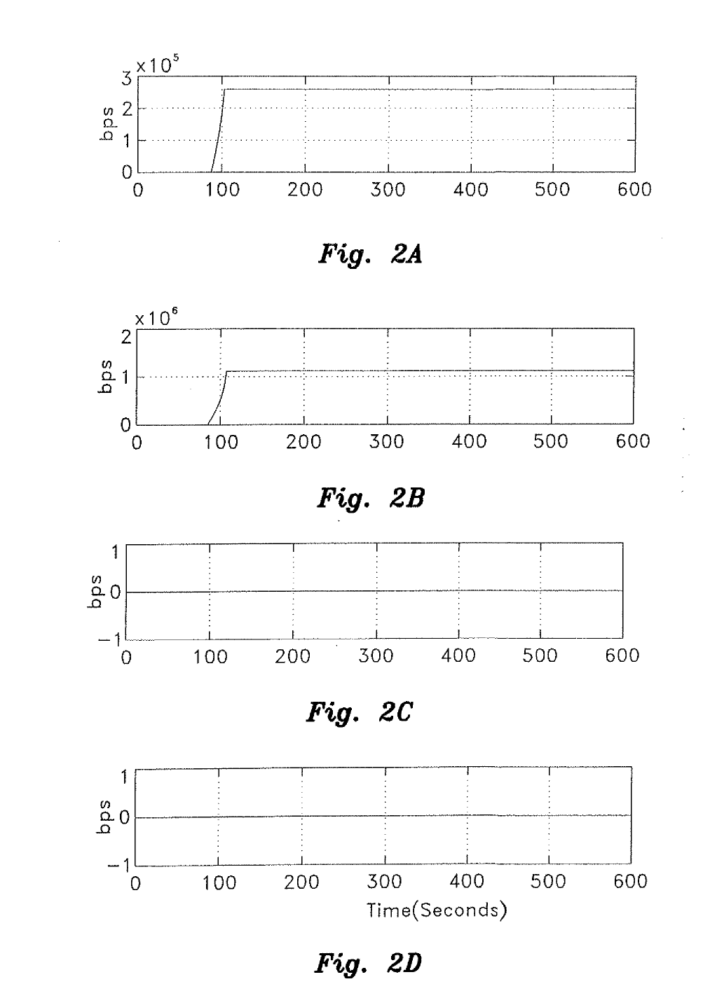

FIGS. 2A, 2B, 2C and 2D illustrate results from a baseline simulation, considering no tunnel establishment in the network 10. In the baseline setup, the local traffic is routed through ISP 300, which is not currently acting maliciously, and the communication path for the local traffic follows the direct route, from R2 to R4 of ISP 300 to R5 and LAN router Rb.

In FIGS. 2A-2D, the X-axis represents the time in seconds and the Y-axis represents the throughput in bits per second. FIGS. 2A-2D show the throughput between R2 and R4, and between R2 and R3 in both directions. It should be noted that traffic flows between R2 and R4 in both directions. On the other hand, traffic does not flow between R2 and R3 in both directions. This is because local traffic is routed through the original path, assuming that ISP 300 is not blocking the Internet access to the local networked system 100. This validates the baseline simulation, and the baseline performance can be compared to the performance of the end solution of the method.

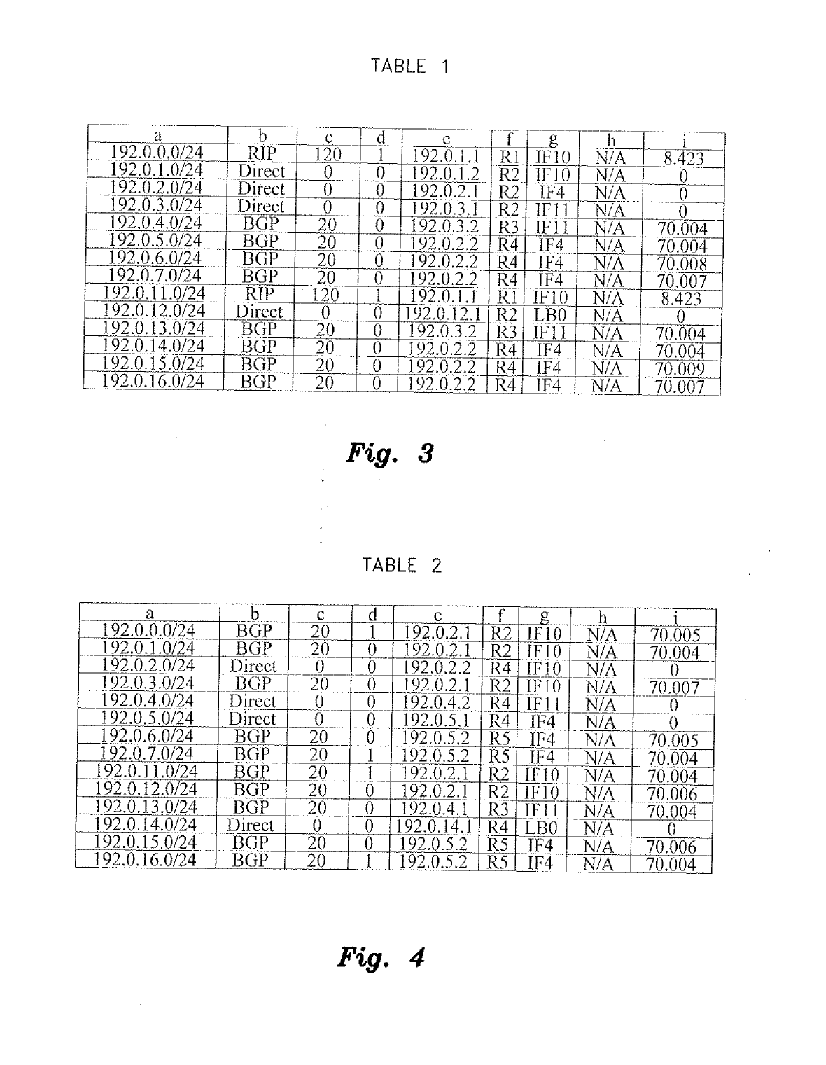

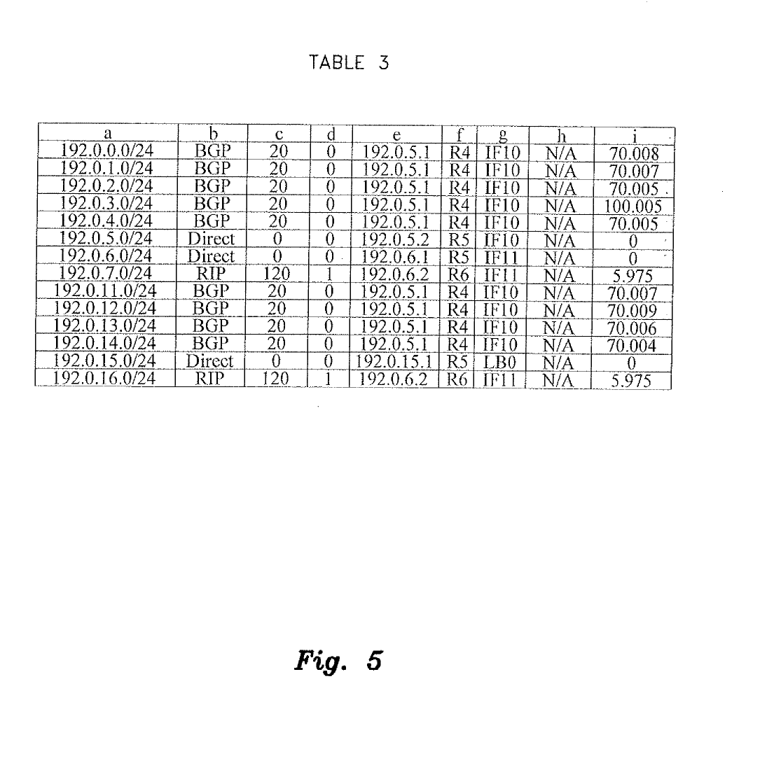

To validate the forwarding settings of the different routers, such as the entry point of the tunnel router, the exit point of the tunnel router, the malicious router, and the proper malicious router interface selection for traffic forwarding, Tables 1, 2 and 3 are provided in FIGS. 3, 4 and 5, respectively. Table 1 provides IP forwarding data for router R2, Table 2 provides the IP forwarding data for router R4 and Table 3 provides the IP forwarding data for router R5, all for the baseline configuration.

From Tables 1, 2 and 3, the incoming and outgoing traffic of the local system 100 can be determined. In the example of FIG. 1, the IP address of LAN router R6 is given as 192.0.7.2, and this belongs to the prefix 192.0.7.0/24. In Table 1, it can be seen that the “Next Hop Node” (see column F of Table 1 of FIG. 3) to this prefix is through router R4. Thus, the outgoing traffic is validated.

In order to simulate a tunnel configuration, the same baseline network for simulation was used, with the addition of the creation of a tunnel between routers R2 and R5 that passes through router R3 of neighboring system 200. As will be described in detail below, neighboring system 200 is pre-established for creating a tunnel to bypass access from system 100 through ISP 300 in the event that ISP 300 blocks the IP address of system 100.

The non-blocked IP address that is provided by the neighboring system 200 is used to create the tunnel. Thus, with the help of a neighboring system 200, a tunnel that passes through the malicious ISP 300 is created. The use of a non-blocked IP address prevents the malicious router R4 from dropping incoming and outgoing local system traffic.

To create a tunnel, a prefix is required to be used for the tunnel interface. In the simulation, the chosen prefix belongs to subnet 200.0.0.0/24. The tunnel starting point IP address is 200.0.0.1, the tunnel ending point IP address is 200.0.0.2, and the tunnel name is Tunnel0. The starting point of the tunnel is interface IF11 of router R2, and its non-tunnel IP address is 192.0.3.1. The ending point of the tunnel is interface IF10 of router R5, and its non-tunnel IP address is 192.0.5.2.

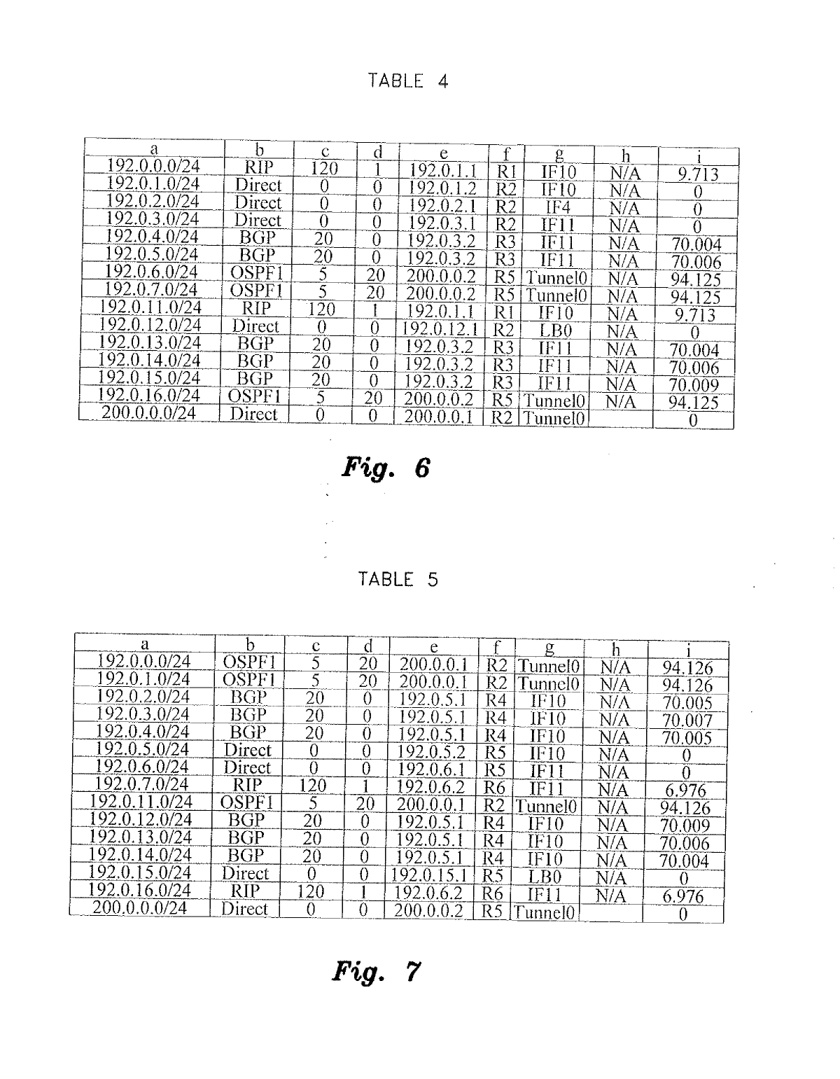

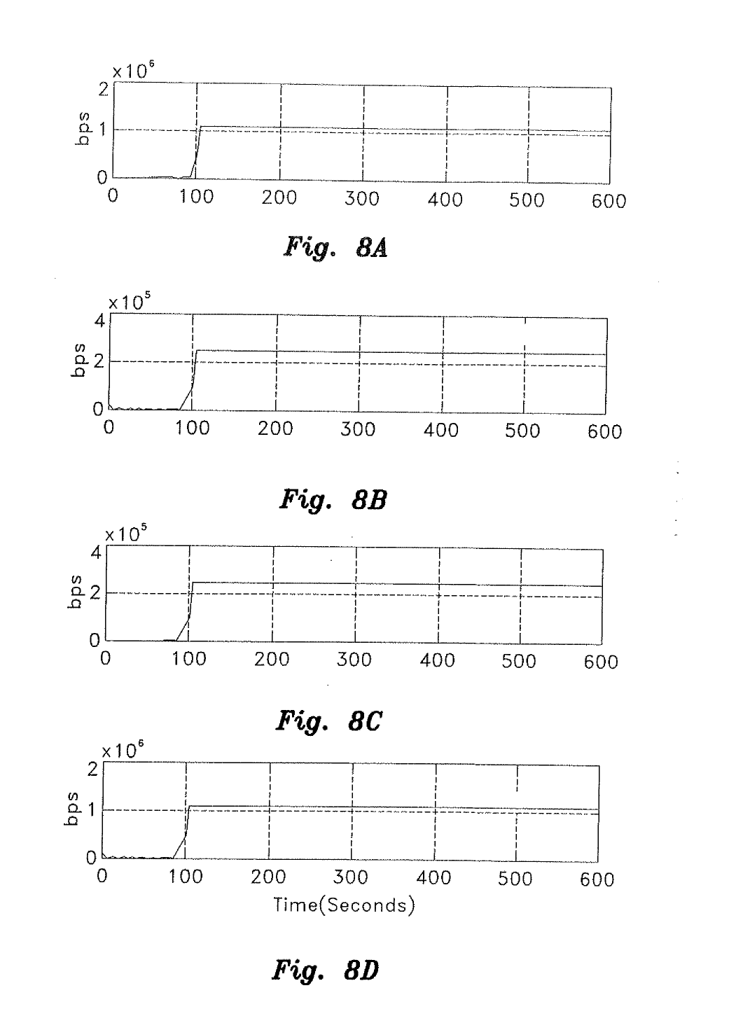

The routing protocol used for the tunnel interface is OSPF, although it should be understood that any routing protocol may be used, such as the Enhanced Interior Gateway Routing Protocol (EIGRP). FIGS. 8A, 8B, 8C and 8D show the IP tunnel traffic received and sent in bits per seconds on routers R2 and R5. To validate that the end solution is set up to forward the traffic properly through the tunnel, the IP forwarding Tables for both routers R2 and R5 may be examined. Table 4 and Table 5, provided in FIGS. 6 and 7, show the IP forwarding for router R2 and router R5, respectively. From Tables 4 and 5, it can be determined that the incoming and the outgoing traffic on router R2 and router R5, respectively, use Tunnel0. This validates the proper setup for the tunnel.

In the present method, it is first determined if the local system 100 is blocked from communicating with the destination system 400. If the local system 100 is blocked from communicating with the destination system 400, then it is determined if a malicious higher-tier Internet service provider 300 is responsible for the blockage of service.

If the local system 100 is blocked by the malicious higher-tier Internet service provider 300, then the malicious higher-tier Internet service provider 300 is identified and communication is established between the local system 100 and a neighboring system 200 that is not blocked by the malicious higher-tier Internet service provider 300. Finally, communications are then transmitted from the local system 100 to the destination system 400 by first transmitting from the local system 100 to the neighboring system 200, and then transmitting from the neighboring system 200 through the higher-tier Internet service provider 300 to the destination system 400.

The neighboring system 200 is a cooperating system that is a neighbor network system to local system 100, and which is in place before the malicious higher-tier ISP blocks access; i.e., neighboring systems are in place before any denial of service in the event that a higher-tier ISP may block service. The destination system 400 is shown as being a neighboring system to the malicious higher-tier ISP 300, although it should be understood that the destination system 400 does not need to be a neighbor system of ISP 300.

When the higher-tier ISP 300 is not malicious, the traffic exchanged between the local system 100 and the destination system 400 follows the normal direct path through the ISP 300. However, when the higher-tier ISP 300 is malicious (i.e., the ISP 300 blocks the IP address of system 100, allowing no communication through ISP 300), then the previous path causes the traffic exchanged between local system 100 and destination system 400 to be intercepted and dropped by ISP 300. To circumvent this malicious activity caused by ISP 300, a tunnel is established between local system 100 and destination system 400. Particularly, a tunnel between router R2 in the local system 100 (i.e., in the blocked system) and router R5 in the destination system 400 is established using any suitable type of tunneling protocol, such as IP-in-IP, GRE, or IPSec.

The established tunnel passes through router R3 of neighboring system 200, and then through router R4 of ISP 300, since ISP 300 has not blocked the IP address of system 200. The non-blocked IP address provided by the neighboring and cooperating system 200 is used to establish the tunnel. The use of the non-blocked IP address prevents the malicious higher-tier ISP router R4 from stopping the establishment of the tunnel between routers R2 and R5, since the non-blocked IP address does not belong to the IP address range of local system 100. Thus, with the help of the neighboring and cooperating system 200, a tunnel that passes through the malicious higher-tier ISP 300 is established.

Once the tunnel is established, the local system 100 and the destination system 400 stop using the normal path for exchanging traffic, and start using the established tunnel for exchanging traffic, as the identity of the exchanged traffic between them is hidden by virtue of the established tunnel. Thus, the traffic exchanged between the local system 100 and destination system 400 will not be intercepted by the malicious higher-tier ISP 300 and will not be dropped.

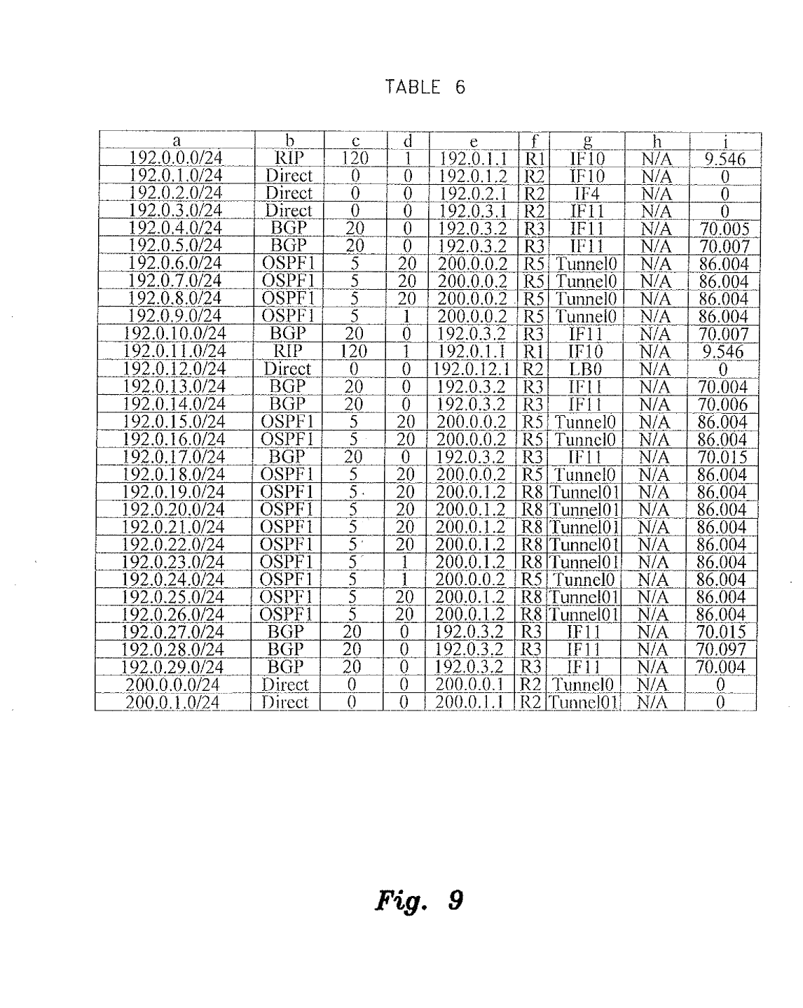

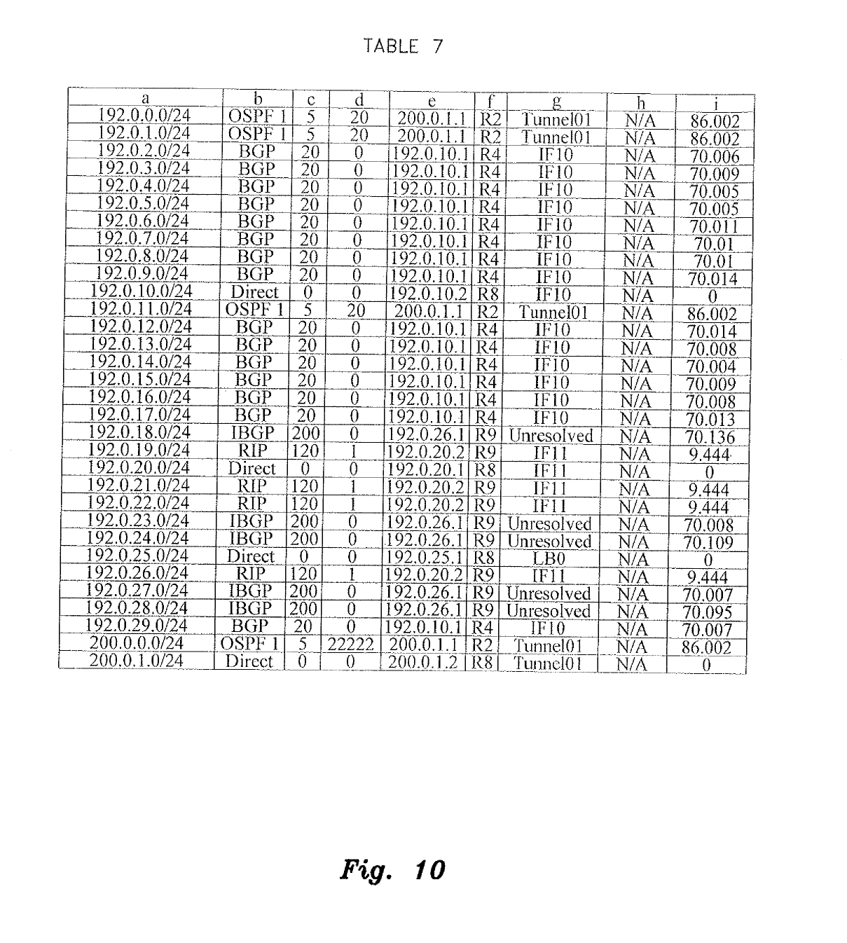

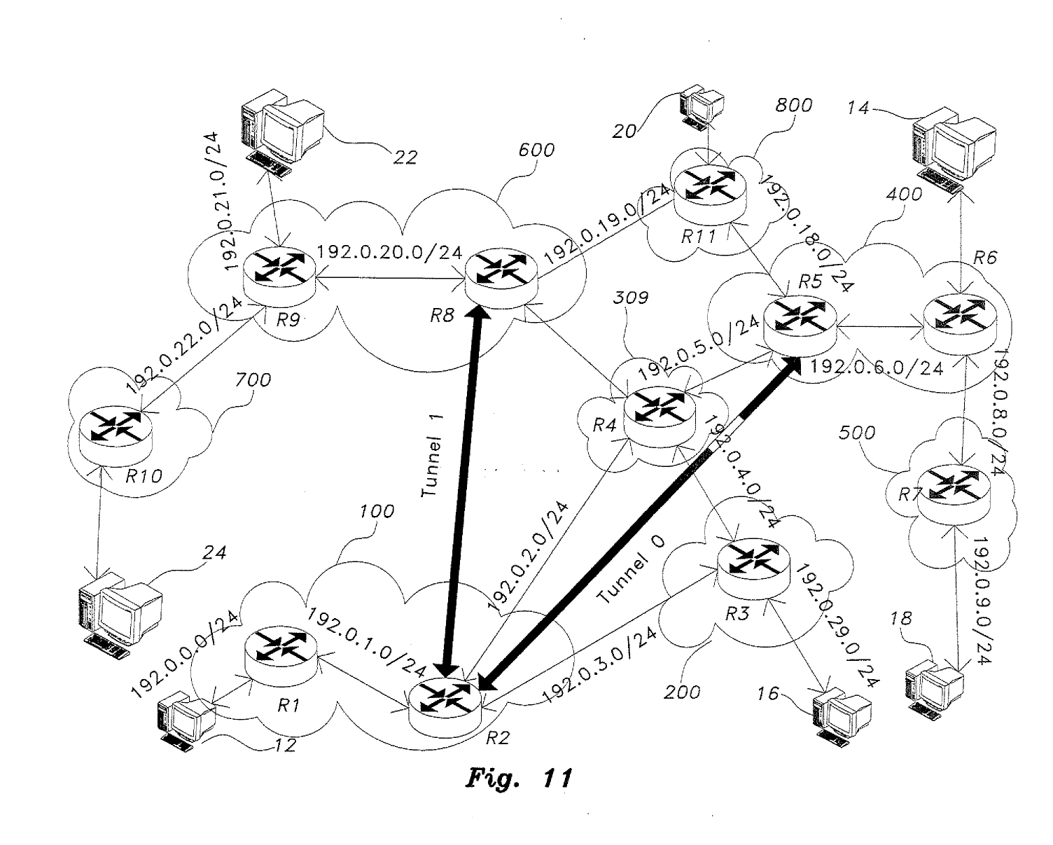

It should be understood that there is no limit to the number of tunnels that can be created. Several tunnel interfaces may be used, as long as the system does not use the same combination of source, destination, and tunnel mode more than once. For purposes of validation, another tunnel interface (Tunnel1) between router R2 and router R8 of system 600 was examined, as shown in FIG. 11. Verification of the creation of multiple tunnels is shown in the IP forwarding table of router R2, provided as Table 6 of FIG. 9. Verification is further provided by the IP forwarding table for router R8, given in Table 7 of FIG. 10. This data confirms the creation of the second tunnel that is terminated at router R8.

To make the above method scalable, the tunnel-based method is scaled to reach multiple systems from the affected system 100, as shown in FIG. 11. In this larger scale configuration, the existing tunnels established by the affected local system 100 are used to send and receive traffic to and from neighboring systems of the end point of the tunnels.

For example, in FIG. 11, if the local system 100 wants to access some services that are located at system 500, then the local system 100 can utilize the existing tunnel established between routers R2 and R5 to send or receive the traffic to or from router R5. Then, the normal routing protocols can be used to deliver the traffic from/to router R5 to/from system 500.

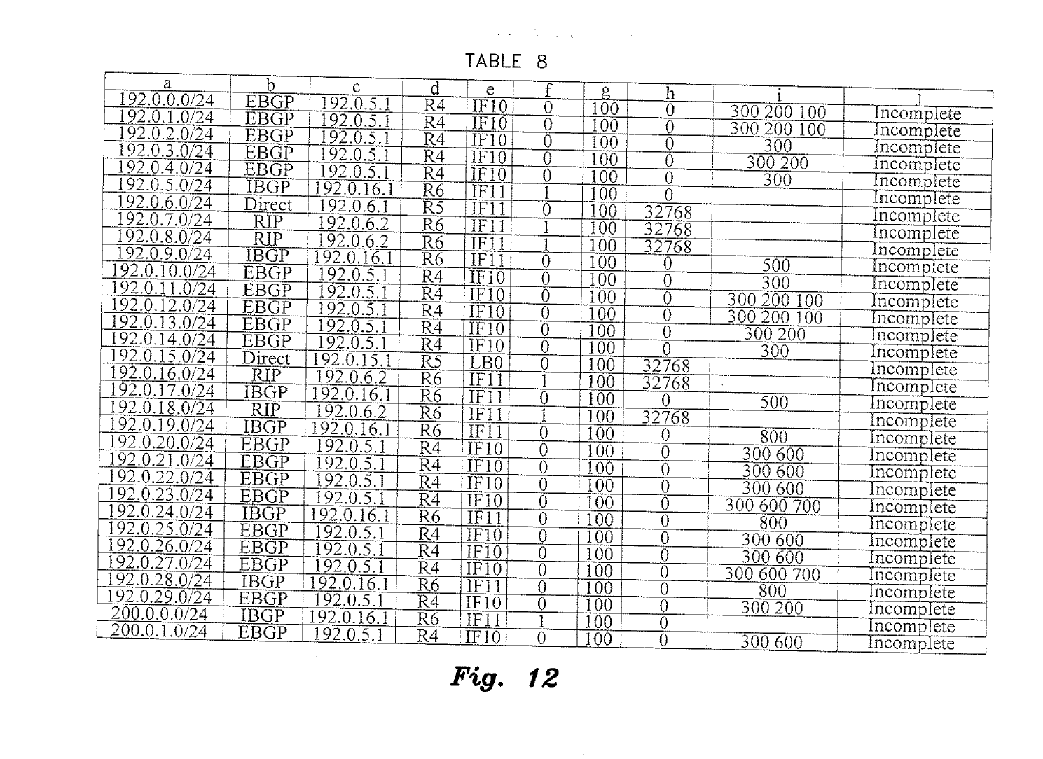

To extend the reach to other systems through a tunnel route, redistribution must be used. Manual redistribution may be used. The purpose of the route redistribution is to propagate routes learned using one protocol into another routing protocol. For example, network 192.0.9.0/24 on the LAN of system 18 in the network is populated as an IBGP route in the BGP forwarding table of router R5, as shown in Table 8 of FIG. 12. In FIG. 11, many such systems are provided. A separate system 16 is connected by local network to neighboring system 200, system 18 is connected via router R7 of system 500 to the destination system 400, system 20 (via router R11 of system 800) links router R5 and router R8 of system 600, and system 600 also has a local router R9 linking system 22 and a neighboring system 700 with a local router R10 for communication with system 24.

Since the prefix 192.0.9.0/24 is known to router R5 through IBGP, and since it is desired to make the same prefix reachable by router R2 through the tunnel established between routers R2 and R5 (which uses OSPF), the prefix must be redistributed at router R5. The route redistribution value at router R5 must be changed to both IBGP and EBGP so that the desired prefix gets redistributed into the tunnel through the use of the OSPF protocol.

To verify the route redistribution, the IP forwarding tables of routers R2 and R5 may be examined. From the routing table of router R2 (Table 6 of FIG. 9), it can be determined that the local region routes traffic destined to prefix 192.0.9.0/24 through Tunnel0. In Table 6, it can also be seen that the local region traffic destined to prefix 192.0.29.0/24 will not utilize the tunnel and, instead, will follow the normal BGP route, as the tunnel is needed only if the traffic is routed through the malicious ISP 300.

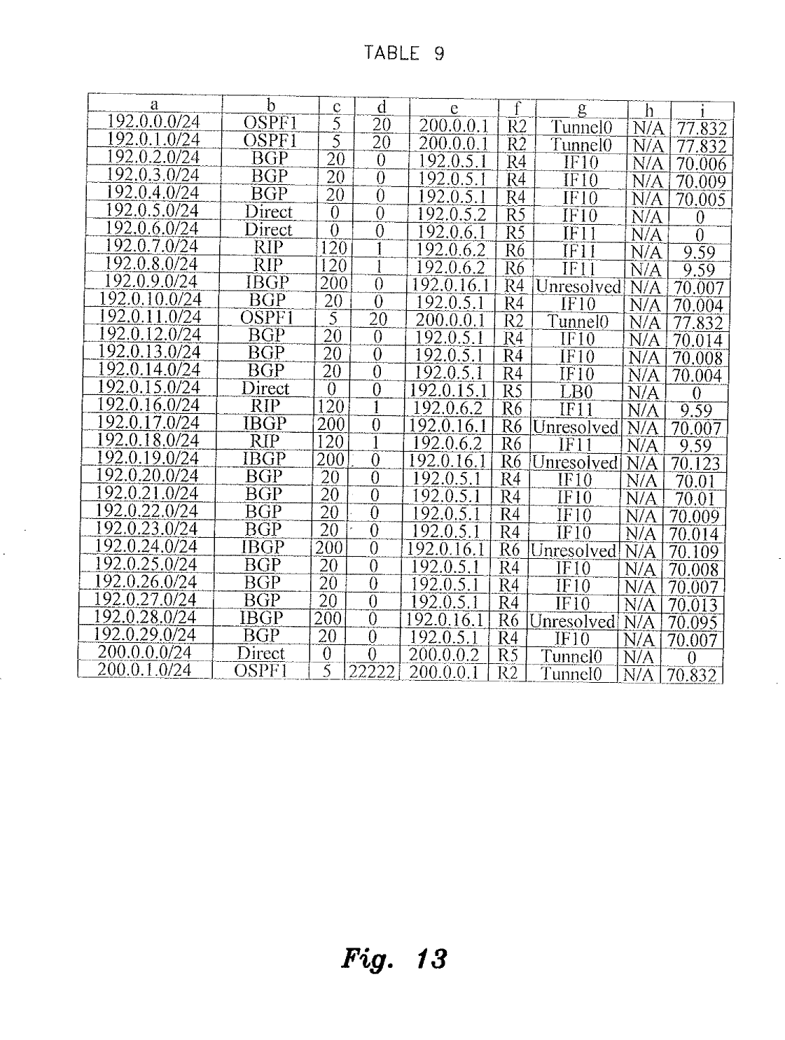

Similarly, examination of the IP forwarding table of router R5 (Table 9 of FIG. 13), shows that Tunnel0 is used to route the traffic to the local system 100. It should be noted that in Tables 6 and 9, some of the values of the Outgoing Interface are set to “Unresolved”. In such cases, BOP is unable to resolve the next hop and the outgoing interface for that specific prefix. To explain the reason behind such behavior, it can be noted that when a BGP router receives a route, the next hop address advertised with it may not be directly connected. Under such a scenario, BGP performs what is commonly referred to as “recursive lookup”. If the next hop address does not exist in the router's routing table, it will then be shown as “Unresolved”.

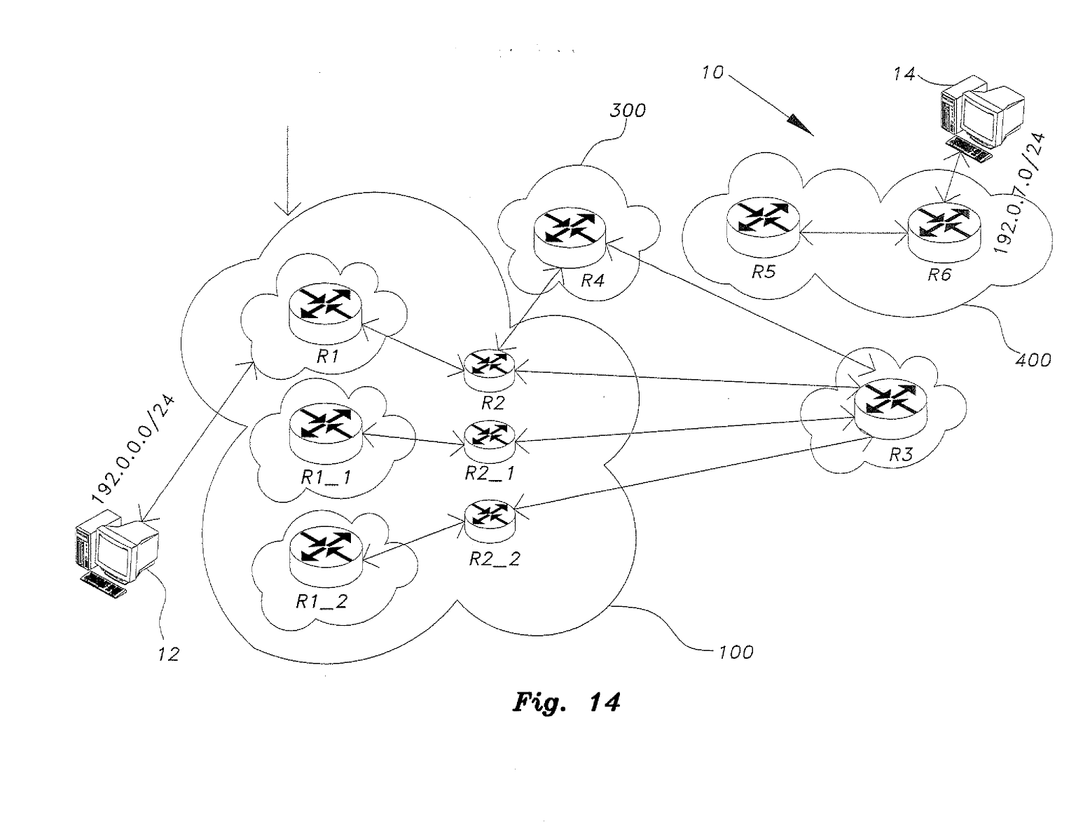

Another tunnel-based solution scalability issue considered is the processing requirement on the gateway router. At the gateway router, every packet is sent or received through the tunnel, and must go through the encapsulation and decapsulation process. This process increases the processing time at the gateway router. However, through the use of multiple gateway routers and pools of public IP addresses, the load will be distributed on the gateway routers. A design for load balancing is shown in FIG. 14. In FIG. 14, the tunnels are distributed among the gateway routers, thus improving performance. In this design, traffic is split from just router R1 to router R2 (within local networked system 100) to a traffic pattern between: router R1 to router R2, router R1_1 to router R2_1, and router R1_2 to router R2_2.

It is to be understood that the present invention is not limited to the embodiments described above, but encompasses any and all embodiments within the scope of the following claims.

1. A tunneling-based method of bypassing Internet access denial, comprising the steps of:
determining that a local system is blocked from communicating with a destination system;
determining that the local system is blocked by a higher-tier Internet service provider;
identifying the higher-tier Internet service provider and establishing communication between the local system and a neighboring system that is not blocked by the higher-tier Internet service provider; and
transmitting communications from the local system to the destination system by first transmitting from the local system to the neighboring system, and then transmitting from the neighboring system through a communication device associated with the higher-tier Internet service provider to the destination system, wherein the transmission of the communications from the local system to the destination system comprises establishment of a tunnel between the local system and the destination system by a protocol selected from the group consisting of: a non-secure IP-in-IP protocol and a secure IPsec protocol.

2. The tunneling-based method of bypassing Internet access denial as recited in claim 1, further comprising the step of transmitting communications from the local system to at least one further destination system by first transmitting from the local system to the neighboring system, and then transmitting from the neighboring system through the communication device associated with the higher-tier Internet service provider to the destination system, and then transmitting from the destination system to the at least one further destination system.

3. The tunneling-based method of bypassing Internet access denial as recited in claim 1, wherein the destination system is a neighboring system of the higher-tier Internet service provider.

4. The tunneling-based method of bypassing Internet access denial as recited in claim 3, further comprising the step of transmitting communications from the local system to at least one further destination system by first transmitting from the local system to the neighboring system, and then transmitting from the neighboring system through the communication device associated with the higher-tier Internet service provider to the destination system, and then transmitting from the destination system to the at least one further destination system.

5-9. (canceled)

10. A tunneling-based method of bypassing Internet access denial, comprising the steps of:
determining that a local system is blocked from communicating with a destination system;
determining that the local system is blocked by a higher-tier Internet service provider;
identifying the higher-tier Internet service provider and establishing communication between the local system and a neighboring system that is not blocked by the higher-tier Internet service provider; and
transmitting communications from the local system to the destination system and to at least one further destination system by first transmitting from the local system to the neighboring system, and then transmitting from the neighboring system through a communication device associated with the higher-tier Internet service provider to the destination system, and then transmitting from the destination system to the at least one further destination system, wherein the transmission of the communications from the local system to the destination system and to the at least one further destination system comprises establishment of a tunnel between the local system and the destination system by a protocol selected from the group consisting of: a non-secure IP-in-IP protocol and a secure IPsec protocol.

11-15. (canceled)

16. A tunneling-based method of bypassing Internet access denial, comprising the steps of:
determining that a local system is blocked from communicating with a destination system;
determining that the local system is blocked by a higher-tier Internet service provider;
identifying the higher-tier Internet service provider and establishing communication between the local system and a neighboring system that is not blocked by the higher-tier Internet service provider; and
transmitting communications from the local system to the destination system by first transmitting from the local system to the neighboring system, and then transmitting from the neighboring system through a communication device associated with the higher-tier Internet service provider to the destination system, wherein the destination system is a neighboring system to the higher-tier Internet service provider, wherein the transmission of the communications from the local system to the destination system comprises establishment of a tunnel between the local system and the destination system by a protocol selected from the group consisting of a non-secure IP-in-IP protocol and a secure IPsec protocol.

17. The tunneling-based method of bypassing Internet access denial as recited in claim 16, further comprising the step of transmitting communications from the local system to at least one further destination system by first transmitting from the local system to the neighboring system, and then transmitting from the neighboring system through the communication device associated with the higher-tier Internet service provider to the destination system, and then transmitting from the destination system to the at least one further destination system.

18-20. (canceled)
